(19) United States
(12) Patent Application Publication
(10) Pub. No.: US 2008/0107920 A1
(43) Pub. Date: May 8, 2008

(54) Thermal barrier coated articles and methods of making the same

(76) Inventors: Raymond Grant Rowe, Niskayuna, NY (US); Jon E. Dickinson, Clifton Park, NY (US)

Correspondence Address: CANTOR COLBURN, LLP, 20 Church Street, 22nd Floor, Hartford, CT, 06103, US

(21) Appl. No.: 11/327,228

(22) Filed: Jan. 6, 2006

(51) Int. Cl. B32B 15/04

(52) U.S. Cl. 428/701; 428/702; 428/632

(57) ABSTRACT

A coated article comprises a substrate; and a multilayer thermal barrier coating disposed on the substrate, the multilayer thermal barrier coating comprising at least a first layer comprising a first ceramic composition having a thermal conductivity less than 1 W/m° K; a second layer having an erosion resistance greater than or equal to dense vertically cracked 8% yttrium stabilized zirconia, wherein percent is based on a total weight of yttrium and zirconia, and a third layer comprising the first ceramic composition or the second composition, wherein the first, second, and third layers are arranged such that the first ceramic composition and the second composition are in alternating layers.

### BACKGROUND

The present disclosure generally relates to thermal barrier coated articles and methods of making the same.

When exposed to high temperatures (i.e., greater than or equal to about 1,300° C.) and to oxidative environments, metals can oxidize, corrode, and become brittle. These environments are produced in turbines used for power generation applications. Thermal barrier coatings (TBCs), when applied to metal components such as turbines, can reduce the effects that high-temperature, and corrosive and oxidative environments have on the metal components.

These thermal barrier coatings typically comprise a ceramic material that is deposited onto a metal substrate or onto a bond coat layer on the metal substrate for better adherence. Metal oxides, such as zirconia (ZrO₂) partially or fully stabilized by yttria (Y₂O₃), magnesia (MgO) or other oxides, have been widely employed as the ceramic material. The ceramic material is typically deposited by air plasma spraying (APS), low pressure plasma spraying (LPPS), or a physical vapor deposition (PVD) technique, such as electron beam physical vapor deposition (EB-PVD), which yields a strain-tolerant columnar grain structure. The bond coat layer can comprise oxidation resistant protective materials such as aluminum, chromium, aluminum alloys, and chromium alloys.

In order for these thermal barrier coatings to remain effective throughout the planned life cycle of the component it protects, it is important that the thermal barrier coatings have and maintain a low thermal conductivity. Recently, advances have been made to lower the thermal conductivity of thermal barrier coatings. However, even with these advances, the materials can disadvantageously have a lower room temperature particle erosion resistance and may even have a lower fracture toughness when compared to zirconia that has been partially or fully stabilized by yttria.

Accordingly, a continual need exists for thermal barrier coatings with low thermal conductivity, while having excellent erosion and particle impact resistance.

### BRIEF SUMMARY

Disclosed herein are thermal barrier coated articles and methods of making the same. In one embodiment, a coated article comprises a substrate; and a multilayer thermal barrier coating disposed on the substrate, the multilayer thermal barrier coating comprising at least a first layer comprising a first ceramic composition having a thermal conductivity less than 1 W/m° K; a second layer having an erosion resistance greater than or equal to dense vertically cracked 8% yttrium stabilized zirconia, wherein the percent is based on a total weight of yttrium and zirconia, and a third layer comprising the first ceramic composition or the second composition, wherein the first, second, and third layers are arranged such that the first ceramic composition and the second composition are in alternating layers.

In another embodiment, a coated article comprises a substrate and a multilayer thermal barrier coating disposed on the substrate. The substrate comprises a metal, a metal alloy, or a combinations comprising at least one of the foregoing. The multilayer thermal barrier comprises a first layer comprising a first ceramic composition comprising stabilized yttrium gadolinium ytterbium, a second layer comprising a second ceramic composition comprising zirconia partially stabilized by 8 weight percent yttria, wherein weight percents are based on a total weight of the zirconia and yttria; and a third layer comprising the first ceramic composition or the second ceramic composition, wherein the first, second, and third layers are arranged such that the first ceramic composition and the second composition are in alternating layers.

In one embodiment, a method of making a coated article comprises disposing on a multilayer thermal barrier coating on a substrate, the multilayer thermal barrier coating comprising at least a first layer comprising a first ceramic composition having a thermal conductivity less than 1 W/m° K; a second layer having an erosion resistance greater than or equal to dense vertically cracked 8% yttrium stabilized zirconia, wherein the percent is based on a total weight of yttrium and zirconia; and a third layer comprising the first ceramic composition or the second composition, wherein the first, second, and third layers are arranged such that the first ceramic composition and the second composition are in alternating layers.

The above described and other features are exemplified by the following Figures and detailed description.

### BRIEF DESCRIPTION OF THE DRAWINGS

Referring to the exemplary drawings wherein like elements are numbered alike in the several Figures:

FIG. 1 illustrates a partial side sectional view of an embodiment of a multilayer thermal barrier coating and coated article; and

FIG. 2 illustrates a partial side sectional view of another embodiment of a multilayer thermal barrier coating and coated article.

### DETAILED DESCRIPTION

Disclosed herein are thermal barrier coated articles and methods of making the thermal barrier coated articles. As will be discussed in greater detail, the thermal barrier coating is a multilayer coating comprising alternating layers of a first ceramic composition and a second ceramic composition. It has unexpectedly been discovered that a synergetic effect in material properties can be obtained when the multilayer coating comprises more than one layer comprising the first ceramic composition or the second ceramic composition. The first ceramic composition is selected to impart low thermal conductivity to the multilayer coating, while the second ceramic composition is selected to impart excellent erosion and particle impact resistance to the multilayer coating.

As used herein, the term low thermal conductivity refers to a thermal conductivity less than 1 Watt per Kelvin-Meter (W/m° K).

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by the context, (e.g., includes the degree of error associated with measurement of the particular quantity). Ranges disclosed herein are inclusive and independently combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc).

Thermal barrier coatings of this disclosure are useful with a wide variety of turbine engine (e.g., gas turbine engine) parts and components that are formed from substrates, e.g., metal substrates comprising a variety of metals and metal alloys, including superalloys. In various embodiments, these parts and components are operated at, or exposed to, high temperatures (i.e., greater than or equal to about 1,300° C.). These turbine engine parts and components can include turbine airfoils such as blades and vanes, turbine shrouds, turbine nozzles, combustor components such as liners and deflectors, augmentor hardware of gas turbine engines, and the like. The thermal barrier coatings can also cover a portion or all of the substrate. For example, with regard to airfoils such as blades, the thermal barrier coatings can be used to protect, cover or overlay portions of the substrate of the airfoil rather than the entire substrate, e.g., the thermal barrier coatings cover the leading and trailing edges and other surfaces of the airfoil, but not the attachment area. While the following discussion of the thermal barrier coatings will be with reference to metal substrates of turbine engine parts and components, it should also be understood that the thermal barrier coatings are useful with substrates of other articles that operate at, or are exposed to, high temperatures.

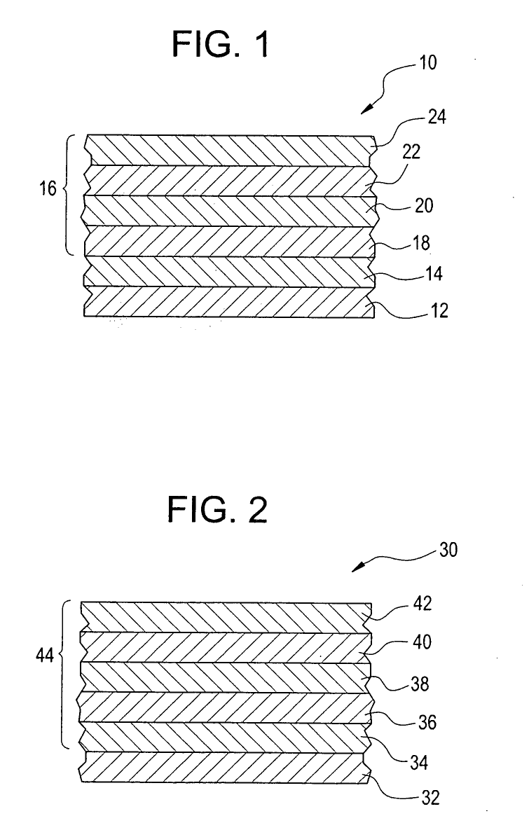

Referring now to FIG. 1, an embodiment of a thermal barrier coated article, generally designated 10 is illustrated. The article 10 comprises a substrate 12. The substrate 12 can comprise metals, metal alloys, and combinations comprising at least one of the foregoing. In one embodiment, the substrate 12 includes metal alloys based on nickel, cobalt and/or iron. For example, the substrate 12 can comprise a high temperature, heat-resistant alloy, e.g., a superalloy. Suitable high temperature alloys include, but are not limited to, those disclosed in U.S. Pat. Nos. 4,116,723 and 5,399,313. As described above, the type of the substrate 12 can vary widely depending on the application, but it is representatively in the form of a turbine part or component, such as an airfoil (e.g., blade) or turbine shroud.

The article 10 can also include an optional bond coat layer 14 disposed in physical communication with the substrate 12 as an adjacent layer. The bond coat layer 14 is formed from a metallic oxidation-resistant material that protects the underlying substrate 12 and enables a thermal barrier coating 16 to better adhere to the substrate 12. Suitable materials for the bond coat layer 14 include, but are not limited to, MCrAlY alloy powders, where M represents a metal such as iron, nickel, platinum or cobalt, or NiAl(Zr) compositions, as well as various noble metal diffusion aluminides such as platinum aluminide, as well as simple aluminides (i.e., those formed without noble metals). The bond coat layer 14 can be applied, deposited or otherwise formed on the substrate 12 by any of a variety of suitable techniques, such as physical vapor deposition (PVD), including electron beam physical vapor deposition (EB-PVD), plasma spray, including air plasma spray (APS) and vacuum plasma spray (VPS), or other thermal spray deposition methods such as high velocity oxy-fuel (HVOF) spray, detonation, or wire spray, chemical vapor deposition (CVD), pack cementation and vapor phase aluminiding in the case of metal diffusion aluminides. In one embodiment, plasma spray or diffusion techniques are employed to deposit the bond coat layer 14. The thickness of the bond coat layer 14 varies depending on the application, but generally the bond coat layer 14 has a thickness of about 25 micrometers to 500 micrometers, specifically 50 micrometers to 350 micrometers.

The thermal barrier coating 16 is disposed on the substrate 12. When the bond coat layer 14 is employed, the thermal barrier coating 16 is disposed in physical communication with the bond coat layer 14. The thermal barrier coating 16 comprises multiple layers. While the number of layers varies depending on the application, the thermal barrier coating comprises at least three layers. The thickness of each layer, as well as the overall thickness of the thermal barrier coating 16 also varies depending on the application. Generally, the thermal barrier coating 16 comprises a thickness sufficient to protect the underlying substrate 12. For example, the overall thickness of the thermal barrier coating 16 is about 25 micrometers to about 2,500 micrometers. Within this range, the thermal barrier coating 16 can be greater than or equal to 75 micrometers, specifically greater than or equal to 300 micrometers. Also within this range, the thermal barrier coating 16 can be less than or equal to 1,500 micrometers, specifically less than or equal to 1,000 micrometers.

In one embodiment, the thermal barrier coating 16 comprises a first TBC layer 18, a second TBC layer 20, a third TBC layer 22, and a fourth TBC layer 24. The first TBC layer 16 is disposed on and in physical communication with the bond coat layer 14. Disposed on and in physical communication with the first TBC layer 16 is the second TBC layer 20. The third TBC layer 22 is disposed between the second TBC layer 20 and the fourth TBC layer 24. In one embodiment, the third layer 22 is disposed in physical communication with each of the second TBC layer 20 and the fourth TBC layer 24. The fourth TBC layer 24 is disposed on and in physical communication with the third TBC layer 22.

The first TBC layer 18 and the third TBC layer 22 comprise a first ceramic composition selected to impart low thermal conductivity to the thermal barrier coating 16. The second TBC layer 20 and the fourth TBC layer 24 comprise a second ceramic composition selected to impart excellent erosion and particle impact resistance to the thermal barrier coating 16. Stated another way, the thermal barrier coating 16 comprises alternating layers of the first ceramic composition and the second ceramic composition.

The first ceramic composition of the first TBC layer 18 and the third TBC layer comprises a low thermal conductivity, i.e., a thermal conductivity less than 1 Watt per Kelvin-Meter (W/m° K). In one embodiment, the thermal conductivity is about 0.25 W/m° K to about 0.75 W/m° K, specifically about 0.25 W/m° K to about 0.75 W/m° K.

In one embodiment, the first ceramic composition comprises about 46 molar percent to about 97 molar percent of a base oxide, about 2 molar percent to about 25 molar percent of a primary stabilizer, about 0.25 molar percent to about 25 molar percent of a Group A dopant, and about 0.25 molar percent to about 25 molar percent of a Group B dopant. The base oxide comprises zirconium oxide (ZrO₂), hafnium oxide (HfO₂), or a combination comprising at least one of the foregoing. The primary stabilizer comprises yttrium oxide (Y₂O₃), dysprosium oxide (Dy₂O₃), erbium oxide (Er₂O₃), or a combination comprising at least one of the foregoing. The Group A dopant comprises scandia oxide (Sc₂O₃), ytterbium oxide (Yb2O3), nickel (II) oxide (NiO), chromium (III) oxide (Cr₂O₃), Cobalt (II) oxide CoO, iron (III) oxide (Fe₂O₃), magnesium (II) oxide (MgO), titanium (IV) oxide (TiO₂), ruthenium (IV) oxide (RuO₂), tantalum oxide (Ta₂O₅), erbium oxide (Er₂O₃), alkaline earth metal oxide, transition metal oxide, or combinations comprising at least one of the foregoing. The group B dopant comprises neodymium oxide (Nd₂O₃), gadolinium oxide (Gd₂O₃), samarium oxide (Sm₂O₃), europium oxide (Eu₂O₃), or combinations comprising at least one of the foregoing. In one embodiment, the first ceramic composition comprises a stabilized yttrium gadolinium ytterbium composition such as those disclosed in U.S. Pat. No. 6,812,176, which is herein incorporated by reference.

The second ceramic composition comprises an erosion resistance greater than or equal to dense vertically cracked 8% yttrium stabilized zirconia, wherein the percent is based on a total weight of the yttrium and zirconia.

Suitable materials for the second ceramic composition include, but are not limited to, zirconia (ZrO₂) partially (e.g., 6 weight percent to 8 weight percent) or fully stabilized (e.g., greater than or equal to 15 weight percent) by yttria (Y₂O₃), magnesia (MgO), or ceria (CeO₂) to yield a tetragonal microstructure that resists phase changes. Other stabilizers for zirconia, include, but are not limited to, hafnia (HfO₂), gadolinia (Gd₂O₃), and dysprosia (Dy₂O₃), erbia (Er₂O₃), neodymia (Nd₂O₃), samarium oxide (Sm₂O₃), ytterbia (Yb₂O₃), and combinations comprising at least one of the foregoing.

In one embodiment, the second ceramic composition comprises yttria-stabilized zirconia (YSZ), and particularly zirconia partially stabilized by yttria. Specifically, the yttria-stabilized zirconia comprises about 4 weight percent to about 8 weight percent yttria, wherein weight percents are based on a total weight of the yttria and zirconia.

The various layers of the thermal barrier coating 16 can be disposed on the substrate by any suitable method. Suitable methods include, but are not limited to, physical vapor deposition (PVD), including electron beam physical vapor deposition (EB-PVD), plasma spray, including air plasma spray (APS) and vacuum plasma spray (VPS), or other thermal spray deposition methods such as high velocity oxy-fuel (HVOF) spray, detonation, or wire spray, and chemical vapor deposition (CVD).

Referring now to FIG. 2, another embodiment of a thermal barrier coated article, generally designated 30 is illustrated. The article 30 comprises a substrate 32. Suitable materials for the substrate 32 include, but are not limited to, those materials discussed above in relation to the substrate 12. A thermal barrier coating 44 is disposed on the substrate 32. The thermal barrier coating 44 comprises a first TBC layer 34, a second TBC layer 36, a third TBC layer 38, a fourth TBC layer 40, and a fifth TBC layer 42. The first TBC layer 34 is disposed on and in physical communication with the substrate 32. Disposed on and in physical communication with the first TBC layer 34 is the second TBC layer 36. The third layer 38 is disposed in physical communication with each of the second TBC layer 36 and the fourth TBC layer 40. The fifth TBC layer 42 is disposed in physical communication with the fourth TBC layer 40.

The first TBC layer 34 and the fourth TBC layer 40 each comprise the first ceramic material discussed above, and the second TBC layer 36 and the fifth TBC layer 42 comprise the second ceramic material also discussed above. The third TBC layer 38 comprises a ceramic composition different than each of the first and second ceramic compositions. In other words, layers comprising the first ceramic material or the second ceramic material may or may not be in physical communication with each other. Rather, various additional layers such as the third TBC layer 38 can be disposed between a layer comprising a first ceramic material (e.g., fourth TBC layer 40) and a layer comprising the second ceramic material (e.g., second TBC layer 36).

Suitable materials for the third TBC layer 38 include, but are not limited to, zirconia (ZrO₂) partially (e.g., 6 weight percent to 8 weight percent) or fully stabilized (e.g., greater than or equal to 15 weight percent) by yttria (Y₂O₃), magnesia (MgO), or ceria (CeO₂) to yield a tetragonal microstructure that resists phase changes. Other stabilizers for zirconia, include, but are not limited to, hafnia (HfO₂), gadolinia (Gd₂O₃), and dysprosia (Dy₂O₃), erbia (Er₂O₃), neodymia (Nd₂O₃), samarium oxide (Sm₂O₃), ytterbia (Yb₂O₃), and combinations comprising at least one of the foregoing.

The various layers of the thermal barrier coating 44 can be disposed on the substrate 32 by any suitable method. Suitable methods include, but are not limited to, physical vapor deposition (PVD), including electron beam physical vapor deposition (EB-PVD), plasma spray, including air plasma spray (APS) and vacuum plasma spray (VPS), or other thermal spray deposition methods such as high velocity oxy-fuel (HVOF) spray, detonation, or wire spray, and chemical vapor deposition (CVD).

Furthermore, the thermal barrier coatings discussed above in relation to FIGS. 1 and 2 can either be a dense vertically cracked (DVC) thermal barrier coating such as those used on high temperature airfoil components or a porous thermal barrier coating such as those used for relatively lower temperature (e.g., temperatures less than about 1,300° C.) components.

It is advantageously noted that thermal barrier coatings disclosed can have improvements in both thermal conductivity and impact resistance when compared to thermal barrier coatings comprising only a single layer or when compared to thermal barrier coatings that do not comprise alternating layers of the first ceramic material and the second ceramic material. As such, articles that have been coated with the thermal barrier coating can have a longer useful life.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A coated article, comprising:
a substrate; and
a multilayer thermal barrier coating disposed on the substrate, the multilayer thermal barrier coating comprising at least
a first layer comprising a first ceramic composition having a thermal conductivity less than 1 W/m° K;
a second layer having an erosion resistance greater than or equal to dense vertically cracked 8% yttrium stabilized zirconia, wherein the percent is based on a total weight of yttrium and zirconia, and
a third layer comprising the first ceramic composition or the second composition, wherein the first, second, and third layers are arranged such that the first ceramic composition and the second composition are in alternating layers.

2. The coated article of claim 1, further comprising a bond coat layer disposed on and in physical communication with the substrate.

3. The coated article of claim 1, wherein the thermal conductivity is about 0.25 W/m° K to about 0.75 W/m° K.

4. The coated article of claim 1, wherein the thermal conductivity is about 0.50 W/m° K to about 0.75 W/m° K.

5. The coated article of claim 1, wherein the first layer is disposed in physical communication with the substrate and is disposed in physical communication with the second layer; and the third layer is disposed in physical communication with the second layer and comprises the first ceramic composition.

6. The coated article of claim 1, wherein the substrate comprises a metal, a metal alloy, or a combinations comprising at least one of the foregoing.

7. The coated article of claim 1, wherein the first ceramic composition comprises
about 46 molar percent to about 97 molar percent of a base oxide, wherein the base oxide comprises zirconium oxide (ZrO₂), hafnium oxide (HfO₂), or a combination comprising at least one of the foregoing;
about 2 molar percent to about 25 molar percent of a primary stabilizer, wherein the primary stabilizer comprises yttrium oxide (Y₂O₃), dysprosium oxide (Dy₂O₃), erbium oxide (Er₂O₃), or a combination comprising at least one of the foregoing;
about 0.25 molar percent to about 25 molar percent of a Group A dopant, wherein the Group A dopant comprises scandia oxide (Sc₂O₃), ytterbium oxide (Yb2O3), nickel (II) oxide (NiO), chromium (III) oxide (Cr₂O₃), Cobalt (II) oxide CoO, iron (III) oxide (Fe₂O₃), magnesium (II) oxide (MgO), titanium (IV) oxide (TiO₂), ruthenium (IV) oxide (RuO₂), tantalum oxide (Ta₂O₅), erbium oxide (Er₂O₃), alkaline earth metal oxide, transition metal oxide, or combinations comprising at least one of the foregoing; and
about 0.25 molar percent to about 25 molar percent of a Group B dopant, wherein the group B dopant comprises neodymium oxide (Nd₂O₃), gadolinium oxide (Gd₂O₃), samarium oxide (Sm₂O₃), europium oxide (Eu₂O₃), or combinations comprising at least one of the foregoing.

8. The coated article of claim 1, wherein the first ceramic composition comprises stabilized yttrium gadolinium ytterbium.

9. The coated article of claim 1, wherein the second ceramic composition comprises zirconia (ZrO₂) partially or fully stabilized by yttria (Y₂O₃), magnesia (MgO), or ceria (CeO₂).

10. A coated article, comprising:
a substrate comprising a metal, a metal alloy, or a combinations comprising at least one of the foregoing; and
a multilayer thermal barrier coating disposed on the substrate, the multilayer thermal barrier coating comprising at least
a first layer comprising a first ceramic composition comprising stabilized yttrium gadolinium ytterbium;
a second layer comprising a second ceramic composition comprising zirconia partially stabilized by 8 weight percent yttria, wherein weight percents are based on a total weight of the zirconia and yttria; and
a third layer comprising the first ceramic composition or the second composition, wherein the first, second, and third layers are arranged such that the first ceramic composition and the second ceramic composition are in alternating layers.

11. The coated article of claim 10, wherein the second layer is disposed on and in physical communication with the first layer, and the third layer comprises the first ceramic composition and is disposed on and in physical communication with the second layer.

12. The coated article of claim 10, wherein the coated article is employed in an environment where temperatures are greater than or equal to 1,300° C.

13. The coated article of claim 16, wherein the coated article is selected from the group consisting of turbine blades and vanes, turbine shrouds, and turbine nozzles.

14. A method of making a coated article, comprising:
disposing a multilayer thermal barrier coating on a substrate, the multilayer thermal barrier coating comprising at least
a first layer comprising a first ceramic composition having a thermal conductivity less than 1 W/m° K;
a second layer having an erosion resistance greater than or equal to dense vertically cracked 8% yttrium stabilized zirconia, wherein the percent is based on a total weight of yttrium and zirconia; and
a third layer comprising the first ceramic composition or the second composition, wherein the first, second, and third layers are arranged such that the first ceramic composition and the second composition are in alternating layers.

15. The method of claim 14, wherein the first layer is disposed in physical communication with the substrate, the second layer is disposed on and in physical communication with the first layer, and the third layer is disposed on and in physical communication with the second layer.

16. The method of claim 14, wherein each of the first, second and third layers is disposed on the substrate by electron beam physical vapor deposition (EB-PVD), air plasma spray (APS), vacuum plasma spray (VPS), high velocity oxy-fuel (HVOF) or chemical vapor deposition (CVD).

17. The method of claim 14, further comprising disposing a bond coating layer on and in physical communication with the substrate, disposing the first layer on and in physical communication with the bond coating layer, disposing the second layer on and in physical communication with the first layer, and disposing the third layer on and in physical communication with the second layer.

18. The method of claim 14, wherein the first ceramic composition comprises stabilized yttrium gadolinium ytterbium.

19. The method of claim 14, wherein the second ceramic composition comprises zirconia (ZrO₂) partially or fully stabilized by yttria (Y₂O₃), magnesia (MgO), or ceria (CeO₂).

20. The method of claim 14, wherein the substrate comprises a metal, a metal alloy, or a combinations comprising at least one of the foregoing.
